(19) United States
(12) Patent Application Publication
(10) Pub. No.: US 2013/0134935 A1
(43) Pub. Date: May 30, 2013

(54) MEDIUM VOLTAGE STAND ALONE DC FAST CHARGER

(71) Applicants: Arindam Maitra, Charlotte, NC (US); Satish Rajagopalan, Knoxville, TN (US); Jih-Sheng Lai, Blacksburg, VA (US); Mark Duvall, Palo Alto, CA (US); Mark McGranaghan, Knoxville, TN (US)

(72) Inventors: Arindam Maitra, Charlotte, NC (US); Satish Rajagopalan, Knoxville, TN (US); Jih-Sheng Lai, Blacksburg, VA (US); Mark Duvall, Palo Alto, CA (US); Mark McGranaghan, Knoxville, TN (US)

(73) Assignee: ELECTRIC POWER RESEARCH INSTITUTE, INC., Charlotte, NC (US)

(21) Appl. No.: 13/479,389

(22) Filed: May 24, 2012

Related U.S. Application Data
(60) Provisional application No. 61/490,282, filed on May 26, 2011.

(51) Int. Cl. H02J 7/02

(52) U.S. Cl. CPC H02J 7/02
USPC 320/109

(57) ABSTRACT

An apparatus for DC fast charging of an electric vehicle includes an active front end AC-DC converter and an isolated DC-DC converter. The active front end AC-DC converter is adapted to rectify a medium voltage alternating current (AC) from a utility grid to a high voltage direct current (DC). The isolated DC-DC converter is adapted to transform the high voltage DC to a low voltage DC for charging the electric vehicle.

This application claims the benefit of Provisional Application No. 61/490,282 filed on May 26, 2011.

### BACKGROUND OF THE INVENTION

This application relates to an apparatus for DC fast charging of electric vehicles, and more particularly, to a medium voltage stand alone DC fast charger for electric vehicles.

Electric vehicles can be charged using either an AC or a DC source. AC charging is typically done either at 120 Vac or 240 Vac (Level 1 and 2 charging), and usually takes four to eight hours to charge the battery of an electric vehicle. Electric vehicles can be charged at a much faster rate (usually within thirty minutes) by directly applying high voltage DC to the battery. This is termed as Level 3 charging.

Several DC fast chargers are being commercially sold. All of these DC fast chargers are 3-phase units that can be supplied off 208/380/400/480/575 Vac. These DC fast chargers are supplied by conventional three-phase transformers that convert medium voltages (˜13 kV L-L) to the required lower AC voltage (FIG. 1). All together, a conventional DC fast charger has the following power conversion stages:
AC-AC stage (3-phase distribution transformer 13 kv→480 Vac).
AC-DC power electronic stage (the first stage within the DC fast charger that converts 480 Vac into an intermediate DC voltage.)
DC-DC power electronic stage (the second and last stage of the DC fast charger that converts the intermediate DC voltage to the voltage required to charge the electric vehicle battery).

At low voltages (208/380/400/480/575 Vac), the input current to the charger is typically large (89 A at 480 Vac, 200 A at 208 Vac), resulting in increased losses and lower efficiency. Most DC fast chargers have efficiency in the 90-92% range. When combined with the efficiency of a three-phase transformer (−99%), the overall system efficiency (excluding losses on the low voltage runs) is between 89 and 91%. If the secondary drops (runs) are included, the efficiency can be expected to decrease further.

### BRIEF SUMMARY OF THE INVENTION

Accordingly, there is a need for an apparatus that provides DC fast charging for electric vehicles at a higher efficiency.

According to one aspect of the invention, an apparatus for DC fast charging of an electric vehicle includes an active front end AC-DC converter adapted to rectify a medium voltage alternating current (AC) to a high voltage direct current (DC), and an isolated DC-DC converter adapted to transform the high voltage DC to a low voltage DC for charging the electric vehicle.

According to another aspect of the invention, a three phase apparatus for DC fast charging of an electric vehicle includes three single phase apparatuses. Each of the single phase apparatuses includes an active front end AC-DC converter adapted to rectify a medium voltage alternating current (AC) to a high voltage direct current (DC), and an isolated DC-DC converter adapted to transform the high voltage DC to a low voltage DC for charging the electric vehicle.

### BRIEF DESCRIPTION OF THE DRAWINGS

The subject matter that is regarded as the invention may be best understood by reference to the following description taken in conjunction with the accompanying drawing figures in which:

FIG. 1 shows a prior art commercial DC fast charger;

FIG. 2 shows an SPI-based stand alone DC fast charger according to an embodiment of the invention;

FIG. 3 shows a modular single phase stand alone DC fast charger;

FIG. 4 shows a multi-level active front end AC-DC boost converter with interleaved DC-DC converter;

FIG. 5 shows a three-phase modular DC fast charger using three single-phase DC fast chargers;

FIG. 6 shows a three-phase modular DC fast charger using a three active front end boost converter circuit;

FIG. 7 shows a typical 75 kVA three-phase distribution transformer; and

FIG. 8 shows a typical 300 kVA three-phase distribution transformer.

### DETAILED DESCRIPTION OF THE INVENTION

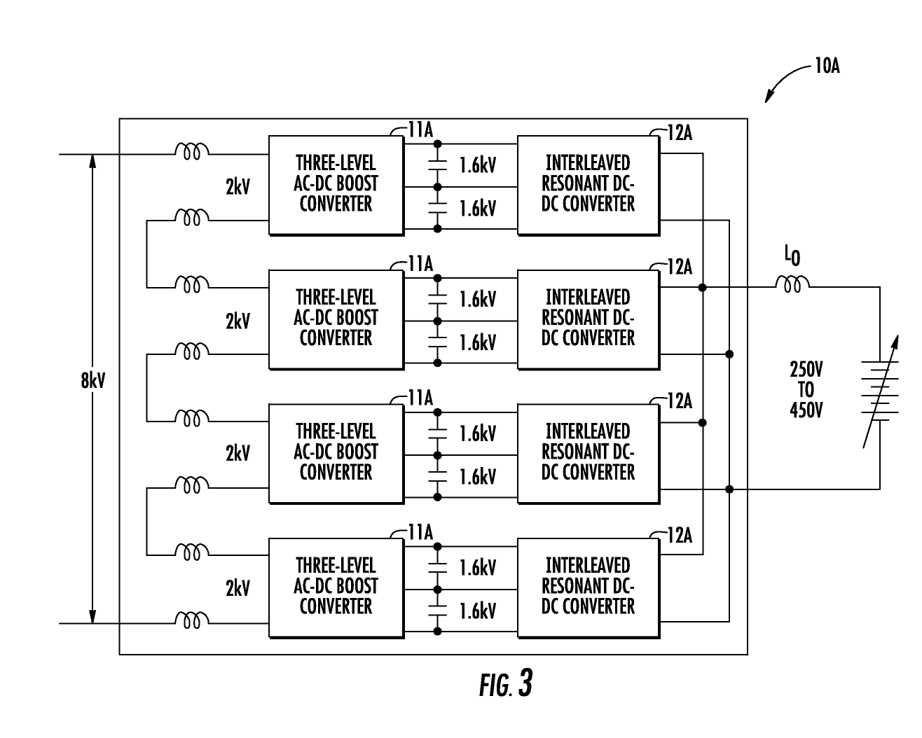

Referring to the drawings, an apparatus according to an embodiment of the invention is illustrated in FIG. 2 and shown generally at reference numeral 10. The apparatus 10 is an SPI-based stand alone DC fast charger and includes an active front end (AFE) AC-DC converter 11 and an isolated DC-DC converter 12.

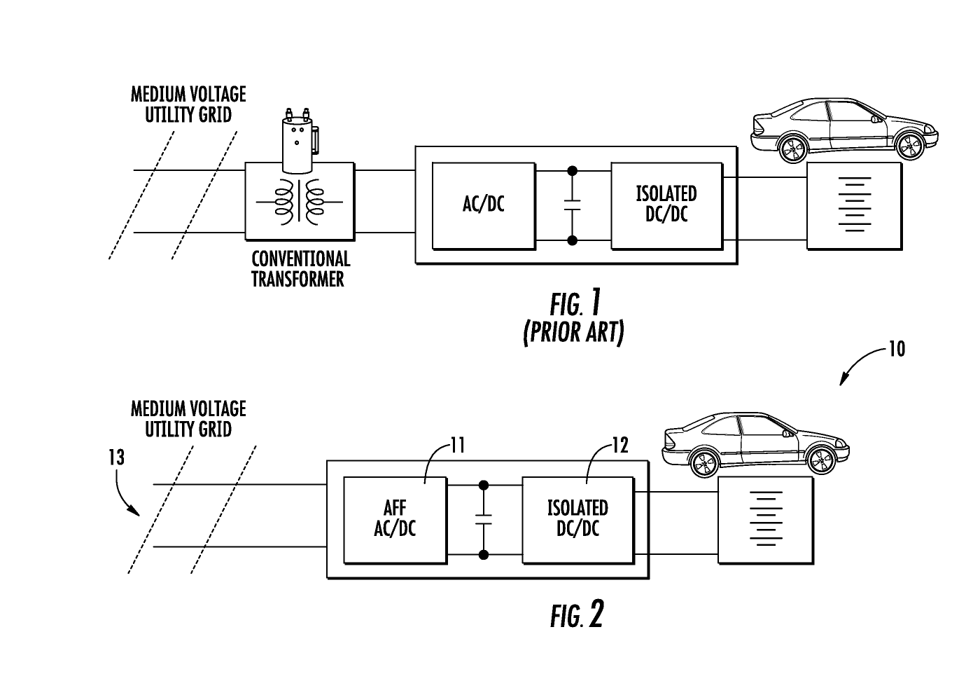

In general, the present invention uses a single/three-phase isolated medium voltage power electronic converter that can take 13 kV L-L voltage from a distribution feeder and provide 50-500 Vdc to charge an electric vehicle battery. This DC fast charger may be designed to adhere to any standard, whether it is the CHAdeMO protocol or the upcoming J2847/2 SAE Level 3 DC fast charger standard. Also, the present invention simplifies the above mentioned commercial system, FIG. 1, to a two stage power converter (FIG. 2):
AC-AC power electronic stage that converts 13 kv to an intermediate high voltage (˜3.5 kV DC).
AC-DC power electronic stage that converts the high voltage DC to the voltage required to charge the electric vehicle battery.

A combination of fewer stages (two in the present converter vs. three in the conventional converter) and high efficiency high voltage power electronics results in an overall higher system efficiency in the order of 95-98%. This is because at high voltage, the input current is less, (around 6-7 A AC) resulting in lower power losses and thereby a higher efficiency. The efficiency of each of the above stages is on the order of 97-99%.

The DC fast charger 10 can be either a single-phase unit or a three-phase unit. As shown, medium voltage AC from a utility grid 13 is rectified to a high voltage DC using the AFE AC-DC converter 11. The high voltage DC is then transformed to a low voltage DC using the isolated DC-DC converter 12 stage. Each stage 11, 12 may use either hard-switched or soft-switched topology. The isolated DC-DC converter 12 also incorporates the charging protocol (CHAdeMO, J2847/2, or other) for communicating with the electric vehicle and the on-board battery management system. The specifications for the stand alone DC fast charger 10 are shown in Tables 1-4.

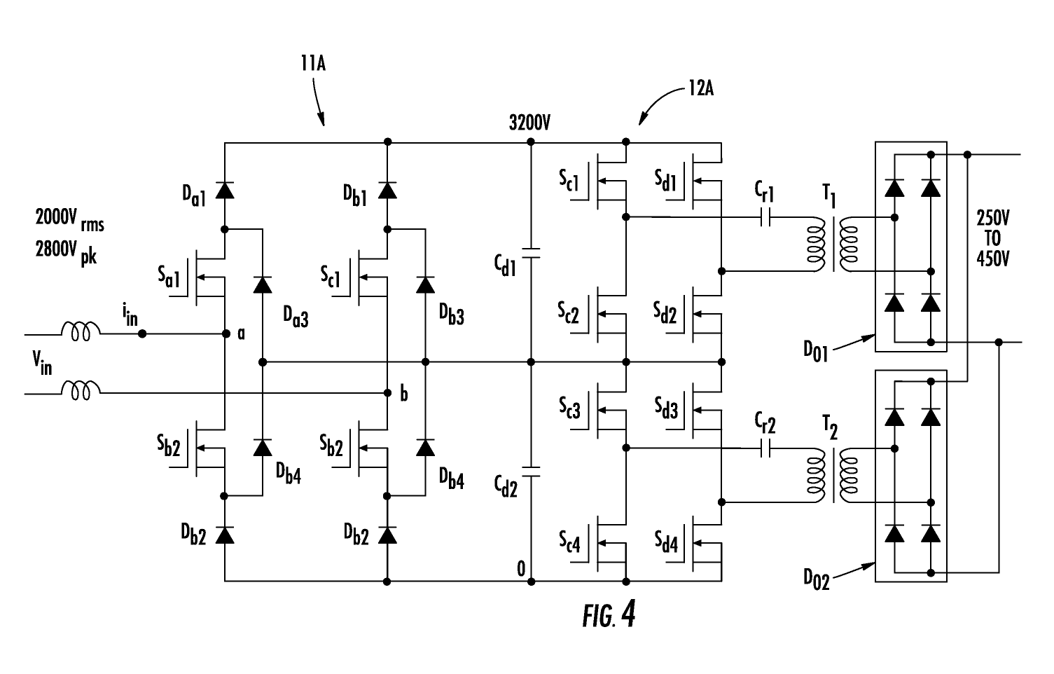

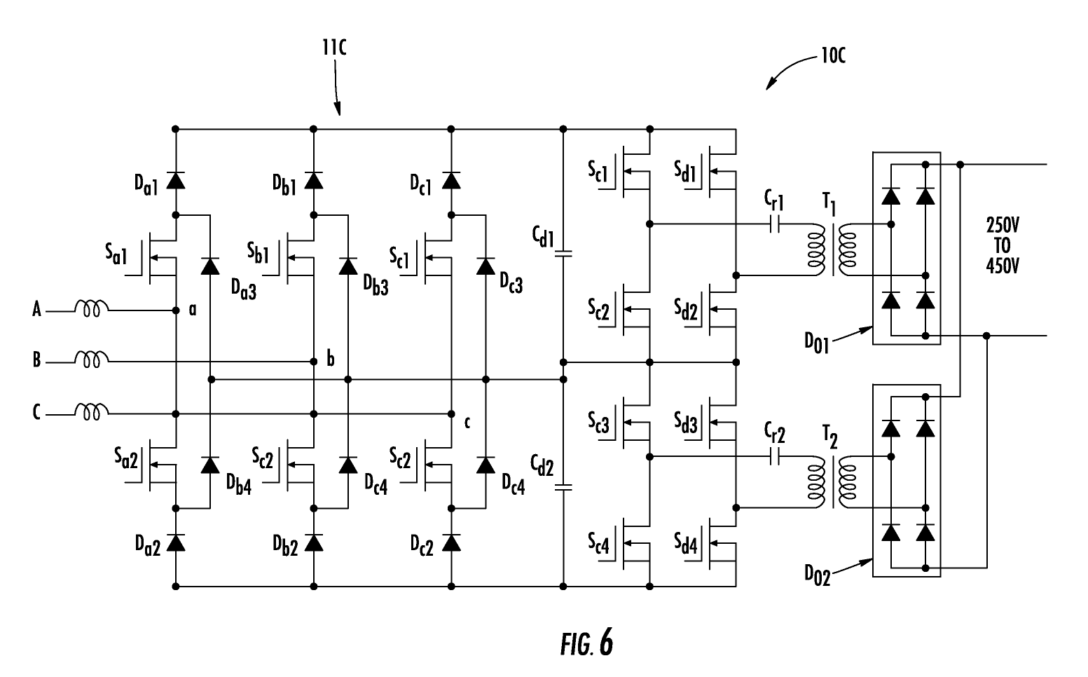

As mentioned earlier, the DC fast charger 10 can be either a single-phase 10A, FIG. 3, or a three-phase unit 10B, FIG. 5. The three-phase option 10B is more efficient and lighter than a single phase option 10A. For large powers (>20 kW), the three-phase option 10B would be the preferred option. At low powers, and where a three-phase feed is unavailable, the single-phase option 10A would offer a viable alternative.

As shown in FIG. 3, the single-phase configuration 10A of the DC fast charger 10 is of a modular design. The single-phase configuration 10A is built by stacking multiple three-level AFE AC-DC boost converter modules 11A with their inputs connected in series. While FIG. 3 shows four stacked levels, the number of stacked levels may vary based on the desired use and configuration. The outputs of each of the AC-DC boost converter modules 11A are passed through isolated DC-DC converters 12A. The outputs of the multiple DC-DC converters 12A are paralleled. This series-input parallel-output modular structure allows the desired input voltage and output current to be achieved.

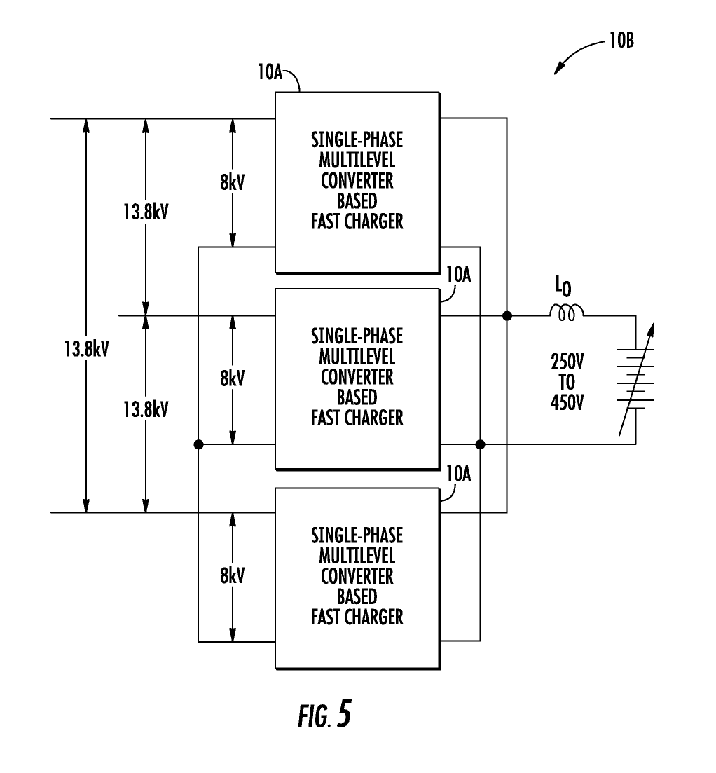

As illustrated in FIG. 4, the AFE AC-DC boost converter module 11A is connected to the DC-DC converter 12A (one stack of the four shown in FIG. 3). The input AFE AC-DC converter module 11A is a multilevel converter (three in this case). A combination of a Si MOSFET/IGBT may be used in conjunction with a SiC diode to obtain the maximum possible efficiency. The DC-DC converter 12A stage is comprised of two interleaved converters that reduce output DC ripple. Further, reduction in DC ripple is obtained when all four of the stacks are paralleled as in FIG. 3. This is obtained by shifting the phase of the DC output in all four stages.

Referring to FIG. 5, the three-phase configuration 10B for the DC fast charger 10 is obtained by using three of the single-phase DC fast chargers 10A shown in FIG. 3. FIG. 6 shows yet another three-phase configuration 10C, where instead of using three single-phase DC fast chargers 10A, a three-phase input AFE circuit 11C is used. This topology would use higher voltage power devices than the configuration involving the three single-phase DC fast chargers 10A.

The key advantages/features of the proposed invention over commercial DC fast charging systems are as follows:
Single or three-phase (isolated) options.
More efficient (95-98%) than commercial DC fast charging systems (89-91%).
Three-phase option offers higher efficiency (1-2%) and reduced size as compared to the single-phase option.
Conforms to any industry-standard fast charging protocol and compliant with all OEM vehicles.

TABLE 1

| Parameter | Range/Description |
|---|---|
| Maximum Power (kW) | 50 |
| DC Output Voltage (V) | 50-500 |
| DC Output Current (A) | 5-125 |
| DC Output Voltage Ripple | <5% |
| Maximum Output | 120 A@400 Vdc |
| Current(A@V) | |
| Noise | 65 dB or less (1 m around; 1 m height) |
| Vehicle Communication | Communication Protocol: CAN2.0B, |
| Protocol | ISO11898 |
| | Comm Transmission Rate: 500 kbps |
| | Cycle: 100 ms +/− 10% |
| Ground Fault Protection | Main circuit: Power supply released on |
| | occurrence of ground faults and short |
| | circuits |
| | Control circuit: Power supply released |
| | on occurrence of ground faults and |
| | short circuits |
| Connector | CHAdeMO compliant 120 A rated |
| Connector Length | 12 ft |

TABLE 2

| Parameter | Range/Description |
|---|---|
| Operating panel | Charge start button: blue, charge stop button: |
| | green |
| | Lighting during standby and flashing light during |
| | operation |
| Emergency Stop | Emergency stop: red |
| | Holding function, prevention window |

TABLE 3

| Parameter | Range/Description |
|---|---|
| Energy and Demand Metering | ANSI C12.20 and IEC687 |
| Demand response (optional) | Capable |
| External Communication | Wireless IEEE 802.11 g, cellular, Zigbee |
| Systems (optional) | SEP 1.0 (2.0 Standard under development) |
| | and Ethernet capabilities |

TABLE 4

| Parameter | Range/Description |
|---|---|
| UL | UL2202, UL2231, and UL2251 electric vehicle |
| | supply equipment |
| UL | UL 50 UL standard for enclosures for electrical |
| | equipment |
| NEC | NEC article 625 electric vehicle charging system |

The efficiency of conventional transformers/DC fast charger combination is calculated using the following equation:

η_{Overall}=η_{3-phaseXfmr}·η_{DCFastCharger}

The DC fast charger efficiency is obtained from datasheets from commercial manufacturers. While, these datasheets do not provide a detailed efficiency vs load curve, the quoted efficiency is usually at full load. It can be assumed that the DC fast charger will operate close to full load while charging the battery. Hence, the single efficiency figure is a sufficient representation of full-load efficiency.

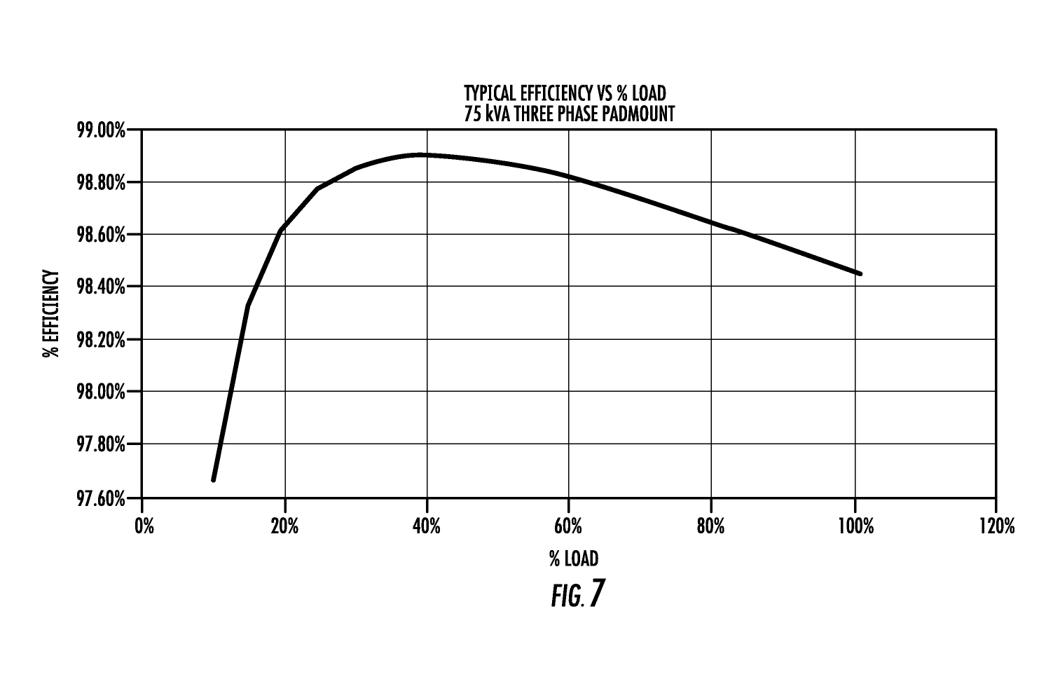

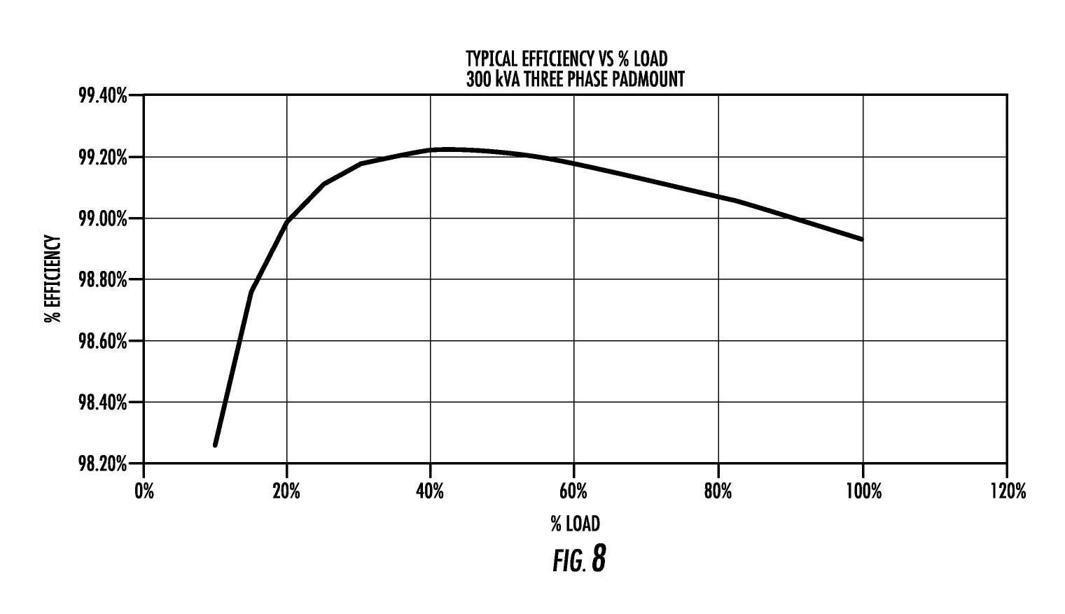

The efficiency of the three-phase transformer is load dependent. Typically, most of the three-phase transformers operate at low-mid-loads and are seldom loaded close to capacity. Table 5 shows actual loading of three-phase transformers in a utility circuit. FIGS. 7 and 8 show the efficiency load curves of a three-phase 75 kVA and a three-phase 300 kVA transformer respectively. As the transformer efficiency is relatively flat over the load curve, the full load efficiency figures from Table 6 are used in the efficiency calculations.

TABLE 5

| Three-Phase Transformer kVA | Loading as % Emergency rating |
|---|---|
| 75 | 57 |
| 300 | 32 |
| 300 | 34 |
| 500 | 14 |
| 500 | 45 |
| 1000 | 11 |
| 1000 | 42 |
| 1500 | 8 |
| 2000 | 15 |

TABLE 6

| Single Phase | | | Three Phase | | |
|---|---|---|---|---|---|
| KVA | DOE | NEMA TP-1 | KVA | DOE | NEMA TP-1 |
| | | | 15 | 98.36 | 98.1 |
| 10 | 98.62 | 98.4 | 30 | 98.62 | 98.4 |
| 15 | 98.76 | 98.6 | 45 | 98.76 | 98.6 |
| 25 | 98.91 | 98.7 | 75 | 98.91 | 98.7 |
| 37.5 | 99.01 | 98.8 | 112.5 | 99.01 | 98.8 |
| 50 | 99.08 | 98.9 | 150 | 99.08 | 98.9 |
| 75 | 99.17 | 99.0 | 225 | 99.17 | 98.9 |
| 100 | 99.23 | 99.0 | 300 | 99.23 | 99.0 |
| 167 | 99.25 | 99.1 | 500 | 99.25 | 99.1 |
| 250 | 99.32 | 99.2 | 750 | 99.32 | 99.2 |
| 333 | 99.36 | 99.2 | 1000 | 99.36 | 99.2 |
| 500 | 99.42 | 99.3 | 1500 | 99.42 | 99.3 |
| 667 | 99.46 | 99.4 | 2000 | 99.46 | 99.4 |
| 833 | 99.49 | 99.4 | 2500 | 99.49 | 99.4 |

As discussed above, the SPI-based DC fast charger 10 consists of two stages: an active front end AC-DC stage 11 and a DC-DC fast charger stage 12. The overall efficiency of an SPI-based fast charger 10 is calculated using the following equation:

η_{Overall}=η_{AFE}·η_{DC-DC}

The efficiency figures for each of the stages used in the overall efficiency calculation are shown in Table 7.

TABLE 7

| SPI Power Stage | Peak efficiency % |
|---|---|
| 1-phase AFE AC-DC converter | 97.5 |
| 3-phase AFE AC-DC converter | 98.5 |
| HV DC-DC Charger | 97.5 |

The overall efficiencies of various DC fast charger systems are calculated as explained in the previous sections, and shown in Table 8. It can be seen that the SPI-based DC fast chargers are more efficient than their conventional counterparts, with the three-phase SPI-based fast charger being the most efficient system of the lot.

TABLE 8

| | DC Fast | Three-Phase | Overall |
|---|---|---|---|
| | Charger | Transformer | Efficiency |
| Manufacturer | Efficiency (%) | Efficiency (%) | (%) |
| Aker Wade/Coulomb | 92 | 99.23¹ | 91 |
| Blink (ECOtality) | 90 | 99.23¹ | 89 |
| AeroVironment | 90 | 99.23¹ | 89 |
| 1-Phase Dedicated SPI- | | | 95² |
| Based Fast Charger | | | |
| 3-Phase Dedicated SPI- | | | 96² |
| Based Fast Charger | | | |

The foregoing has described an apparatus for DC fast charging of electric vehicles. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

We claim:

1. An apparatus for DC fast charging of an electric vehicle, comprising:
(a) an active front end AC-DC converter adapted to rectify a medium voltage alternating current (AC) to a high voltage direct current (DC); and
(b) an isolated DC-DC converter adapted to transform the high voltage DC to a low voltage DC for charging the electric vehicle.

2. The apparatus according to claim 1, wherein the apparatus is of a single phase configuration.

3. The apparatus according to claim 2, wherein the single phase configuration is of a modular design.

4. The apparatus according to claim 3, wherein the modular design includes:
(i) a plurality of three-level active front end AC-DC converters with each of the inputs of the plurality of AC-DC converters connected in series; and
(ii) a plurality of isolated DC-DC converters with each of the outputs of the plurality of DC-DC converters connected in parallel, wherein outputs for each of the plurality of AC-DC converters are connected to inputs of a respective one of the plurality DC-DC converters.

5. The apparatus according to claim 3, wherein the modular design includes at least one three-level active front end AC-DC converter connected to at least one isolated DC-DC converter.

6. The apparatus according to claim 1, wherein the isolated DC-DC converter includes two interleaved converters adapted to reduce output DC ripple.

7. The apparatus according to claim 1, wherein the apparatus is of a three phase configuration.

8. The apparatus according to claim 7, wherein the three phase configuration includes a three phase active front end AC-DC converter.

9. A three phase apparatus for DC fast charging of an electric vehicle, comprising three single phase apparatuses, each of the single phase apparatuses having:
(a) an active front end AC-DC converter adapted to rectify a medium voltage alternating current (AC) to a high voltage direct current (DC); and
(b) an isolated DC-DC converter adapted to transform the high voltage DC to a low voltage DC for charging the electric vehicle.
